(19) United States
(12) Patent Application Publication
(10) Pub. No.: US 2014/0247499 A1
(43) Pub. Date: Sep. 4, 2014

(54) SECURITY STRUCTURE COMPRISING A REFLECTIVE OPTICAL STRUCTURE, AND ASSOCIATED METHOD

(71) Applicant: ARJOWIGGINS SECURITY, Boulogne-Billancourt (FR)

(72) Inventors: Pierre Doublet, Saint Brice (FR); Michel Camus, Rives Sur Fure (FR)

(73) Assignee: ARJOWIGGINS SECURITY, Boulogne-Billancourt (FR)

(21) Appl. No.: 14/195,393

(22) Filed: Mar. 3, 2014

Related U.S. Application Data
(63) Continuation of application No. PCT/IB2012/054457, filed on Aug. 30, 2012.

(30) Foreign Application Priority Data
Sep. 2, 2011 (FR) 1157806

(51) Int. Cl. B42D 15/00; G02B 5/09; G02B 3/00; G02B 5/08

(52) U.S. Cl. CPC B42D 15/0026; G02B 5/08; G02B 5/09; G02B 3/0037
USPC 359/627; 359/838

(57) ABSTRACT

A security element for integration into documents for authentication thereof. The security element comprises a substrate. A reflective optical structure and a reference pattern are disposed on the same side of the substrate. The reflective optical structure is made up of an array of Fresnel lenses. The reference pattern appears in the foreground when observed by an observer. A virtual image of the observer appears in the background behind the foreground pattern.

CROSS-REFERENCE TO RELATED APPLICATIONS

This nonprovisional application is a continuation of and claims priority to PCT Patent Application No. PCT/IB2012/054457, entitled “SECURITY STRUCTURE COMPRISING A REFLECTIVE OPTICAL STRUCTURE, AND ASSOCIATED METHOD,” filed Aug. 30, 2012, which claims priority to French Patent Application No. FR 11/57,806 having the same title and a filing date of Sep. 2, 2011, both of which are herein incorporated by reference.

### BACKGROUND OF THE INVENTION

1. Field of the Invention

This invention relates to security structures. More specifically, it relates to security structures intended for insertion into security documents.

2. Brief Description of the Related Art

The expression “security document” is understood to mean a means of payment, such as a banknote, a check, or a restaurant voucher, an identity document, such as an identity card, a Visa, a passport or a driving license, a lottery ticket, a transport ticket or even a ticket for entrance to sporting or cultural events.

In order to prevent attempts to falsify or counterfeit a security document, it may be useful for a security structure to be easy to authenticate and/or identify.

It is known to produce security structures comprising lenticular arrays that are associated with specific prints, in order to produce movement, depth and/or stereoscopic effects. The company SECURENCY sells such structures under the MOTION® trademark.

Such security structures exploit an optical structure one face of which is exposed to air, so that the difference between the refractive indices of air and of the material of the structure causes the desired refraction of light rays.

Optical effects obtained using lenticular arrays have especially been described in the article “The History of Integral Print Methods” which is an excerpt from “Lens Array Print Techniques” by David E. Roberts and Trebor Smith, the article “The moire magnifier” by M. C. Hutley et al. 1994 IOP publishing ltd, and the “Academy of the Sciences” publication from the session of 2 Mar. 1908.

Various examples of security structures comprising optical structures are especially known from publications FR 2 952 194, WO 2007/133613,

US 2008/0182084, US 2005/0180020 and US 2008/0160226.

FR 2 952 194 discloses a substrate bearing on an optical structure and a reference pattern. The optical structure creates an image of a comparative pattern. At least two comparative patterns may be located at different distances from the optical structure, in particular from the focal point of a lens of the optical structure, so that the images of these comparative patterns appear in different planes. An additional pattern may be produced by printing in order to form a backdrop on which the image is observed through the optical structure of the comparative patterns. As a variant, the optical structure focuses light into image points and the substrate comprises only the reference pattern and the optical structure. The optical structure may be formed by metallizing a lenticular array, the latter possibly comprising a Fresnel lens. Furthermore, the optical structure may be covered with a lacquer that cancels out the effects thereof.

WO 2007/133613 describes a substrate comprising a lenticular array and a pattern spatially coordinated with images produced by the lenticular array.

US 2008/0182084 teaches that the effect of lenses may be cancelled out by applying an adhesive to their surface. In one example, the structure comprises a substrate bearing, on one side, a lenticular array having lacquer-coated zones, and on the other, a diffractive structure and micro-images.

US 2005/0180020 discloses a multilayer structure comprising a lenticular array that may be overprinted.

US 2008/0160226 discloses a structure in which images formed by a lenticular array may be observed superposed on a pattern formed by demetallization.

Thus, lenticular arrays have been used in the prior art to allow them to be superposed on printed patterns so as to create movement effects, especially moiré magnification effects, on observation.

One of the drawbacks of moiré magnification effects is the need to be able to associate very small prints with the array of lenses, thereby requiring complex manufacturing processes.

There is a need to attain security structures comprising an optical structure capable of producing novel optical effects able to contribute to the authentication and/or identification of an object, especially in a way that is simple.

However, in view of the art considered as a whole at the time the present invention was made, it was not obvious to those of ordinary skill in the field of this invention how the shortcomings of the prior art could be overcome.

BRIEF SUMMARY OF THE INVENTION

The long-standing but heretofore unfulfilled need for security structures capable of incorporating an adhesive in order to improve their incorporation into a security document while preserving the visual properties of their optical structures is now met by a new, useful, and nonobvious invention.

Thus, one object of the invention, in one of its aspects, is a security structure comprising at least one pattern appearing in the foreground, and at least one reflective optical structure creating a virtual image of the observer, which image is seen in the background behind the foreground pattern.

Thus, the invention may allow an image formed by a foreground pattern and a backdrop formed by a virtual background image of the observer to be observed simultaneously. The reflective optical structure, which in particular comprises an array of reflective lenses, may create a smaller virtual image of the observer in the preferred case of convex lenses, or an enlarged virtual image in the case of concave lenses.

The array of reflective lenses may advantageously comprise an array of Fresnel lenses and a reflective layer.

By virtue of the invention, a three-dimensional (3D) backdrop effect may be obtained by way of the pattern appearing in the foreground and the reflective optical structure creating a virtual image of the observer, which image is seen in the background, using manufacturing processes that are simpler than those employed in the prior art.

The structure may comprise a substrate between the foreground pattern and the reflective optical structure.

The substrate may be at least partially transparent or translucent. The substrate may, for example, be or comprise a film made of a transparent or translucent thermoplastic, for example polyester or PET.

The reflective optical structure may completely cover the face of the substrate bearing the optical structure, or, as a variant, cover it only partially.

The reflective optical structure may be equivalent to a convex mirror, especially a spherical convex mirror. In particular, the reflective optical structure may comprise an array of Fresnel lenses and a reflective layer.

The reflective layer may be arranged so as to lie between the foreground pattern and the array of Fresnel lenses or so that the array of Fresnel lenses lies between the foreground pattern and the reflective layer. The reflective layer may be a metal layer, made of aluminum for example, especially covering the Fresnel lenses. The metal layer may have a thickness comprised between 0.1 and 0.3 μm. The metal layer may be applied to the Fresnel lenses by evaporation, so that the metal layer closely follows the shape of the relief of the lenses in order to form the reflective optical structure without cancelling out the lenticular effect.

The metal layer may be covered with a smoothing lacquer, especially intended to allow the foreground pattern to be applied, preferably by printing. In addition, the smoothing lacquer may allow the array of metallized Fresnel lenses to be protected.

As a variant, the reflective layer may be a reflective composition, especially covering the Fresnel lenses on the side of their concave face.

The reflective layer may be associated with one or more other security layers, especially a magnetic, fluorescent and/or phosphorescent layer.

The optical structure may be produced by imprinting, especially by thermal imprinting or by imprinting followed by ultraviolet curing. In particular, the array of Fresnel lenses may be formed by debossing or embossing a lacquer (or resin). The lacquer may for example contain an epoxy or acrylic resin, PET or polyester, inter alia.

The array of Fresnel lenses may for example be embossed in the lacquer and the convex face of the lenses may be covered with a metal layer.

As a variant, the array of Fresnel lenses may be debossed in the lacquer and a reflective composition may be applied to the debosses of the lenses on the side of the concave face.

The optical structure may or may not extend lengthwise and/or widthwise from one edge of the substrate to the other.

The substrate may present one or more zones without the optical structure and one or more zones covered with the optical structure.

The optical structure may be discontinuous. In particular, the optical structure may consist of a set of separate optical substructures that are either identical or not. These optical substructures may comprise elementary optical structures, for example arrays of lenses, these elementary optical structures possibly being or not being separate, and possibly being or not being identical. These optical substructures may especially correspond to arrays of Fresnel lenses, allowing the reflection of the observer to be seen in the background.

The optical structure may be elongate along a longitudinal axis.

The optical structure may have any geometric shape, for example of or not of polygonal outline, for example square, rectangle, diamond, triangle, trapezium, parallelogram, circular, elliptic, inter alia.

All the elementary optical structures forming the optical structure may or may not have the same geometric shape. The elementary optical structures may for example all take the form of parallelograms. The elementary optical structures, whether identical or not, may be arranged on the security structure at regular intervals, or not.

The optical structure may comprise an array of lenses, especially an array of Fresnel lenses, of a thickness for example comprised between 2 and 30 μm, for example equal to 6 μm, and a diameter of the lenses for example comprised between 1 and 20 mm, for example equal to 10 mm.

The foreground pattern may be formed by printing, for example macro printing or holographic printing, by metallization or demetallization. The foreground pattern may be made of metal. A metal pattern arranged on a reflective metal layer is particularly advantageous, and therefore forms an immediately recognizable security feature.

The pattern may, for example, correspond to a sign, logo, symbol, individual, object or alphanumeric character.

The pattern may for example be added to the substrate using a screen-printing, intaglio, laser, inkjet, micro-lithography, rotogravure or offset printing process.

The pattern may be printed inter alia in opaque, fluorescent, phosphorescent, thermochromic, photochromic, translucent and/or transparent inks that are or are not colored, and that may be seen with the naked eye under ultraviolet (UV) and/or infrared (IR) light.

The pattern is preferably arranged at least partially covering the array of (especially Fresnel) lenses.

Preferably, at least 75% of the area of the pattern covers the array of lenses.

One and the same pattern may be superposed on a plurality of lenses.

The pattern is closer to the observer than the reflective optical structure, the latter creating a virtual image of the observer, which image is seen in the background behind the pattern. The focal plane of the reflective optical structure may be located between the reflective surface and the foreground pattern, or behind the reflective surface.

Furthermore, the external faces of the security structure may be coated with a heat-sealing lacquer, especially in order to facilitate adhesion of the structure to a security document, especially a security paper, incorporating it. The heat-sealing lacquer may allow the uniformity of the surface of the external faces of the security structure to be increased. For example, the heat-sealing lacquer may allow the uniformity of the surface of a reflective composition, for example an ink based on small particles, deposited on Fresnel lenses debossed in a lacquer, to be increased. Furthermore, the heat-sealing lacquer may form a protective layer. Advantageously, the presence of a heat-sealing lacquer does not cancel out the optical effects of the reflective optical structure. The heat-sealing lacquer may partially or totally cover the surface of the external faces of the security structure.

The array of Fresnel lenses may extend over only part of the structure, especially bounding a lens-free zone extending from at least one edge of the structure, the reflective layer partially extending into this zone.

The security structure may comprise a pattern arranged partially covering the array of lenses and partially covering said lens-free zone.

The security structure may form a security thread, a security film or a patch. Preferably, the security structure is a security thread. The width of the security structure may for example be larger than or equal to 4 mm, better 5 mm, even better 6 mm, and for example is comprised between 6 and 8 mm, better between 6 and 10 mm.

The optical structure may be formed on the substrate, from the same material or not, by addition or not.

The thickness of the substrate is for example comprised between 5 and 100 μm, and preferably between 20 and 30 μm. The substrate may have a constant thickness. The thickness of the substrate may optionally be chosen depending on the optical structure, for example depending on the focal length of this optical structure, so as to obtain the desired optical effect.

Another object of the invention, in another of its aspects, is a document, especially a security document, incorporating a security structure such as defined above.

The security structure may or may not extend from one edge of the document to the other.

The security structure may or may not be incorporated in one or more windows in the document.

A single or both of the faces of the security structure incorporated in the document may be partially or completely visible.

The document, or the security structure that it contains, may comprise one or more additional security elements such as defined below.

Among additional security elements, certain are detectable by eye, under daylight or artificial light, without any particular apparatus being required. These security elements for example comprise colored fibers or flakes, or partially or completely metallized or printed threads. These security elements are called first-level security elements.

Other types of additional security elements are detectable only using a relatively simple apparatus, such as a lamp emitting in the ultraviolet (UV) or infrared (IR). These security elements for example comprise fibers, flakes, strips, threads or particles. These security elements may or may not be visible to the naked eye, for example being luminescent under a Wood's lamp emitting at a wavelength of 365 nm. These security elements are called second-level security elements.

Other types of additional security elements require a more sophisticated detection apparatus to detect them. These security elements are, for example, capable of generating a specific signal when they are subjected, simultaneously or not, to one or more sources of exterior excitation. The automatic detection of the signal allows, if required, the document to be authenticated. These security elements for example comprise tracers taking the form of active materials, particles or fibers, capable of generating a specific signal when these tracers are subjected to an optronic, electric, magnetic or electromagnetic excitation. These security elements are called third-level security elements.

The one or more additional security elements present within the document, or the security structure that it contains, may have first-, second-, or third-level security features.

Another object of the invention, in another of its aspects, is a method for authenticating a document such as defined above, in which information relating to the authenticity of the document is generated at least by observing the latter.

### BRIEF DESCRIPTION OF THE DRAWINGS

For a fuller understanding of the invention, reference should be made to the following detailed description, taken in connection with the accompanying drawings, in which:

FIG. 1A is a cross-sectional view of a first exemplary embodiment of a security structure according to the present invention.

FIG. 1B is a cross-sectional view of a second exemplary embodiment of a security structure according to the present invention.

FIG. 2 is a top view of the first or the second embodiment of the security structure.

FIG. 3A is a schematic side view depicting a Fresnel lens.

FIG. 3B is a schematic side view depicting a convex lens.

FIG. 4 is a diagram depicting a principle of observation of an object through a Fresnel lens.

FIG. 5 is a top view of a document into which the security structure according to the present invention has been integrated.

FIG. 6 is a top view of an embodiment of the security structure according to the present invention.

### DETAILED DESCRIPTION OF THE PREFERRED EMBODIMENT

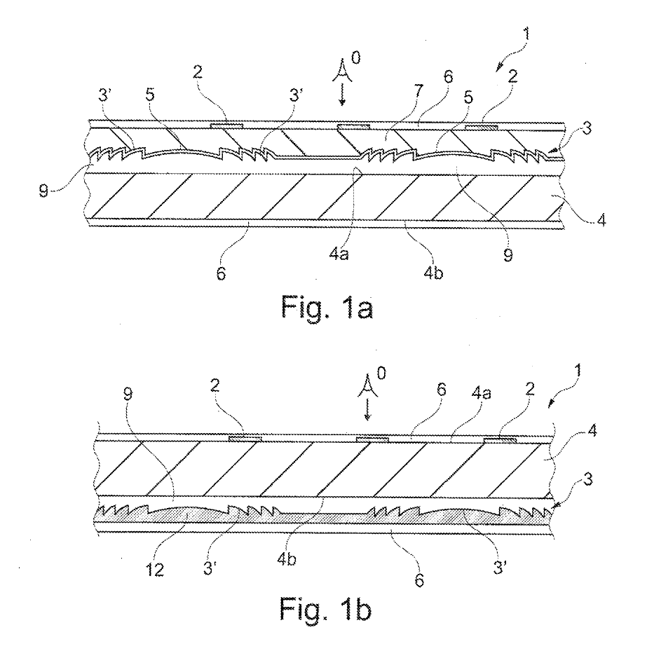

FIG. 1A shows an example security structure 1 according to one embodiment of the invention.

The security structure 1 for example takes the form of a security thread of width comprised between 4 and 10 mm, and preferably between 4 and 8 mm.

The security structure 1 comprises a substrate 4, for example made of polyethylene terephthalate (PET). On the side of a face 4a of the substrate 4, i.e. on that face opposite the face 4b, a reflective optical structure 3 and patterns 2, which appear in the foreground when observed by an observer O, are formed.

The reflective optical structure 3 comprises an array of Fresnel lenses 3′ and a reflective layer 5.

The array of Fresnel lenses 3′ is for example formed by embossing (in the observation direction) a lacquer 9, for example made of an epoxy or acrylic resin, PET or polyester. The array of Fresnel lenses 3′ imprinted in the lacquer 9 may have a thickness comprised between 1 and 10 μm.

The reflective layer 5 is located between the foreground patterns 2 and the array of Fresnel lenses 3′.

The reflective layer 5 is a metal layer, for example made of aluminum, covering the array of Fresnel lenses 3′.

The metal layer 5 may have a thickness comprised between 0.1 and 0.3 μm. It may be applied to the Fresnel lenses by evaporation or vacuum deposition so as to closely follow the shape of the relief of the lenses in order to form the reflective optical structure 3 without cancelling out the lenticular effect.

Furthermore, the metal layer 5 is, in this example, covered with a smoothing lacquer 7 intended to facilitate application of the foreground patterns 2. In addition, the smoothing lacquer 7 may allow the array of metallized Fresnel lenses 3′ to be protected. As a variant, the foreground patterns 2 may be applied directly, especially by printing, to the metal layer 5 without a smoothing lacquer 7 being present.

As another variant, the foreground patterns 2 may be applied, especially by printing, to a separate carrier, especially a thin PET carrier, that is adhesively bonded to the reflective optical structure 3, the smoothing lacquer 7 then being replaced by an adhesive layer.

As a variant, the array of Fresnel lenses 3′ is imprinted directly in the substrate 4.

The patterns 2 may, for example, be produced by printing, especially by macro printing or holographic printing, metallization or demetallization.

Furthermore, a heat-sealing lacquer 6 covers both external faces of the security structure 1 in order to allow the security structure 1 to be fastened to the security document 10.

FIG. 1B shows a variant embodiment of a security structure 1 according to the invention.

In this example, the reflective layer 5 is located so that the array of Fresnel lenses 3′ lies between the foreground patterns 2 and the reflective layer 5.

The array of Fresnel lenses 3′ is debossed (in the opposite direction to observation) in the lacquer 9 and a reflective composition 12 is applied to the debosses of the lenses on the side of their concave face. The reflective composition 12 may contain an ink based on small particles, for example nanoparticles, especially metal particles, which allow a reflective effect to be created on observation by O.

The debossing process may be preferred in that it is simpler than the embossing process, and in that it does not require the application of a smoothing lacquer 7.

As a variant, a reflective metal layer 5 is deposited, especially by evaporation, on the array of Fresnel lenses 3′ on the side of their concave face (in the debosses) and a smoothing lacquer 7 is optionally applied so as to cover the reflective optical structure 3 in order to flatten it and protect it.

The reflective layer 5 may be associated with one or more other security layers, especially a magnetic, fluorescent and/or phosphorescent layer.

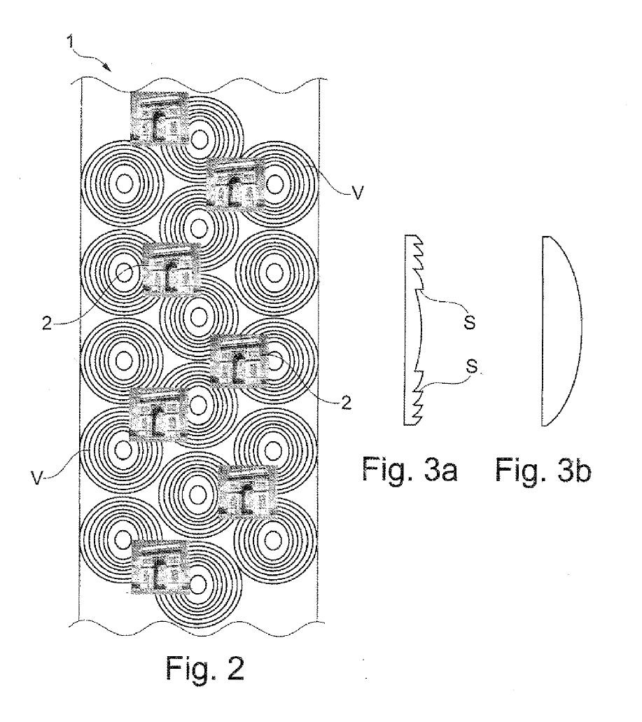

FIG. 2 shows a bottom view of FIG. 1A or FIG. 1B, illustrating what the observer O may see when they look at the security structure 1 from the side of the face 4a of the substrate 4.

The reflective optical structure 3 is able to create a virtual image V of an observer O who looks at the security structure 1 from the side of the face 4a of the substrate 4. This virtual image V is seen in the background by the observer O, behind the foreground patterns 2. This thus allows a three-dimensional (3D) effect to be obtained on observation.

FIGS. 3A and 3B respectively show an example Fresnel lens and an example convex lens having equivalent focal lengths.

A Fresnel lens, as illustrated in FIG. 3A, may be obtained from a convex lens, as illustrated in FIG. 3B, by subdividing it into slices that are equidistant in the plane of the lens, and removing slice portions that have a constant thickness, in order to obtain a thin slab.

Thus, the Fresnel lens comprises striations S that get closer together with distance from the center of the lens. The height of the striations S is for example about 1 μm near the center of the lens and about 11 μm on the periphery of the lens.

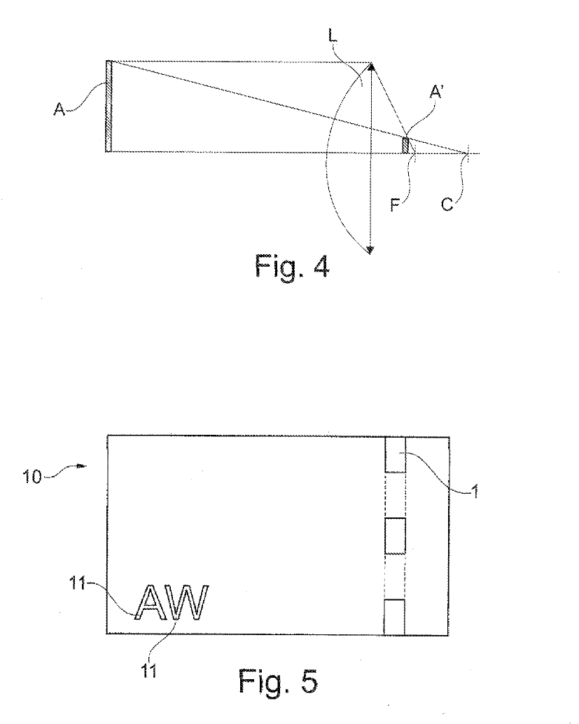

FIG. 4 shows the principle behind the observation of an object A seen using a convex mirror formed by a metallized, and therefore reflective, Fresnel lens L. In FIG. 4, C represents the center of curvature of the lens and F the focal point of the lens. Advantageously, it will be understood that a convex mirror obtained by means of a reflective Fresnel lens allows a thin, flat security structure 1 that is perfectly adapted to security documents such as banknotes, and the thickness of which is about 100 μm, to be obtained. Specifically, a conventional 5 to 10 mm lens having an equivalent radius of curvature would have a thickness of 200 to 300 μm, which is undesirable for application to security documents.

The image A′ of the object A appears smaller when observed using a Fresnel lens L forming a convex mirror. Moreover, the further the object A is distant from the Fresnel lens L forming the convex mirror, the smaller the size of the observed image A′. Furthermore, the greater the Fresnel curvature L forming the convex mirror, the smaller the image A′ appears.

FIG. 5 shows an example security document 10 incorporating a security structure 1 according to the invention, for example such as shown in FIGS. 1A and 1B.

The security structure 1 is for example inserted into one or more windows in the security document 10. As a variant, the security structure 1 may be completely or partially incorporated into the bulk of the security document 10.

In addition, the security document 10 may comprise other security elements 11, for example such as described above.

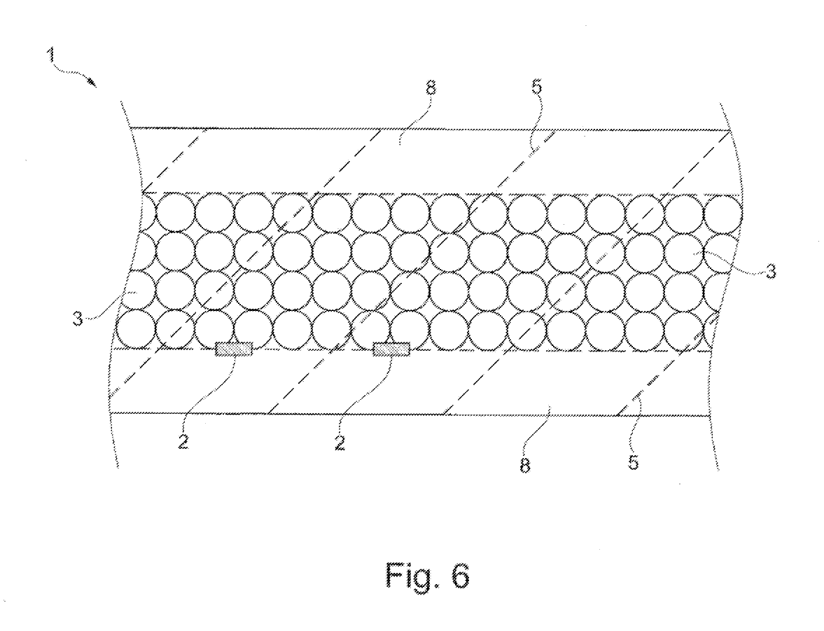

FIG. 6 shows a variant embodiment of the security structure 1 in FIG. 1A. The structure 1 is shown such as observed from the face 4a of the substrate 4, the reflective optical structure 3 and the reflective layer 5 being drawn with dotted lines, and the patterns 2 with solid lines. The security structure 1 may or may not be coated, on one or both of its faces, with a heat-sealing lacquer 6 (not shown).

In this example, the reflective optical structure 3 comprises an array of Fresnel lenses only extending over only part of the structure 1, thereby bounding two zones 8 bordering the structure 1, which zones are free from lenses. The reflective metal layer 5 for example extends right over the security structure 1.

When the observer O observes the structure 1 from the face 4a of the substrate 4, they may thus see both a smaller virtual image V of themselves formed by the array of metallized Fresnel lenses forming a convex mirror, and an image of themselves reflected by the zones 8 that are free from lenses but on which the reflective layer 5 is found, which zones are equivalent to a planar mirror. The virtual image V created by the array of lenses forming the convex mirrors may thus be compared to the image reflected by the zones 8 free from lenses.

The foreground patterns 2 may be located partially covering the array of lenses and partially covering the lens-free zones 8 forming the convex mirrors.

The expression “comprising a” must be understood as being synonymous with “comprising at least one”, unless the contrary is specified.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A security structure comprising:
at least one pattern appearing in the foreground; and
at least one reflective optical structure creating a virtual image of the observer, which image is seen in the background behind the foreground pattern.

2. The structure as claimed in claim 1, the reflective optical structure comprising an array of reflective lenses.

3. The structure as claimed in claim 1, comprising a substrate between the foreground pattern and the reflective optical structure.

4. The structure as claimed in claim 1, the reflective optical structure being equivalent to a convex mirror, especially a spherical convex mirror.

5. The structure as claimed in claim 1, the reflective optical structure comprising an array of Fresnel lenses and a reflective layer.

6. The structure as claimed in claim 5, the array of Fresnel lenses being imprinted in a lacquer.

7. The structure as claimed in claim 5, the reflective layer being a metal layer and the array of Fresnel lenses being embossed in the lacquer, the metal layer being applied to the embosses.

8. The structure as claimed in claim 7, the metal layer being covered with a smoothing lacquer especially intended to allow the foreground pattern to be applied.

9. The structure as claimed in claim 5, the reflective layer being a reflective composition, and the array of Fresnel lenses being debossed in the lacquer, the reflective composition being applied to the debosses.

10. The structure as claimed in claim 1, the foreground pattern being formed by printing, by metallization or demetallization.

11. The structure as claimed in claim 1, being coated, on its external faces, with a heat-sealing lacquer.

12. The structure as claimed in claim 5, the array of Fresnel lenses extending over only part of the structure, especially bounding a lens-free zone extending from at least one edge of the structure, the reflective layer at least partially extending into this zone.

13. The structure as claimed in claim 12, comprising a pattern arranged partially covering the array of lenses and partially covering said lens-free zone.

14. The structure as claimed in claim 1, forming a security thread or a patch.

15. A document incorporating a security structure as claimed in claim 1.

16. A method for authenticating a document as claimed in claim 15, in which information relating to the authenticity of the document is generated at least by observing the latter.
